(19) United States
(12) Patent Application Publication
(10) Pub. No.: US 2003/0150439 A1
(43) Pub. Date: Aug. 14, 2003

(54) Vortex generator for engines

(76) Inventor: Ming-Hsu Hsu, Tai-Ping City (TW)

Correspondence Address: TROP PRUNER & HU, PC, 8554 KATY FREEWAY, SUITE 100, HOUSTON, TX, 77024, US

(21) Appl. No.: 10/179,805

(22) Filed: Jun. 25, 2002

(30) Foreign Application Priority Data
Feb. 8, 2002 (TW) 091201775

(51) Int. Cl. F02M 29/02

(52) U.S. Cl. 123/592

(57) ABSTRACT

A vortex generator is adapted for use with an engine so as to enhance combustion efficiency of the engine. The vortex generator includes a tubular body and a plurality of curved blades. The tubular body is adapted to be disposed anterior to an air intake port of the engine and is formed with an air inlet, an air outlet, and an inner wall surface that defines an air passage extending from the air inlet to the air outlet. A plurality of curved blades are mounted in the air passage on the inner wall surface of the tubular body, and cooperate to direct air that flows through the air passage from the air inlet to the air outlet to form a vortex which is supplied to the air intake port. As such, the vortex can mix with fuel in the engine to enhance the combustion efficiency.

### CROSS-REFERENCE TO RELATED APPLICATION

This application claims priority of Taiwan patent Application No. 091201775, filed on Feb. 8, 2002.

### BACKGROUND OF THE INVENTION

1. Field of the Invention

This invention relates to a vortex generator, more particularly to a vortex generator adapted for use with an engine so as to enhance combustion efficiency of the engine.

2. Description of the Related Art

Conventional internal combustion engines are known to suffer from poor combustion efficiency that leads to poor engine exhaust emission quality, which is a major source of air pollution. While it has been proposed heretofore to subject air that is supplied to an air intake port of the engine to various types of pre-treatment, such as filtration and exposure to far infrared ray emissions, there is always a need to find other alternatives for enhancing the engine combustion efficiency.

### SUMMARY OF THE INVENTION

Therefore, the object of the present invention is to provide a vortex generator adapted for use with an engine so as to enhance combustion efficiency of the engine.

According to this invention, a vortex generator comprises a tubular body and a plurality of curved blades. The tubular body is adapted to be disposed anterior to the air intake port and is formed with an air inlet, an air outlet, and an inner wall surface that defines an air passage extending from the air inlet to the air outlet. The air inlet and the air outlet are adapted to be respectively disposed distal and proximate relative to the air intake port. A plurality of curved blades are mounted in the air passage on the inner wall surface of the tubular body, and cooperate to direct air that flows through the air passage from the air inlet to the air outlet to form a vortex, which is supplied to the air intake port. As such, the vortex can mix with fuel in the engine to enhance the combustion efficiency.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view illustrating a vortex generator adapted for use with an engine so as to enhance combustion efficiency of the engine;

FIG. 2 is a perspective view of the preferred embodiment of a vortex generator according to the present invention; and

FIG. 3 is a perspective view of the preferred embodiment of a vortex generator according to the present invention when rolled to surround a tube axis.

### DETAILED DESCRIPTION OF THE PREFERRED EMBODIMENT

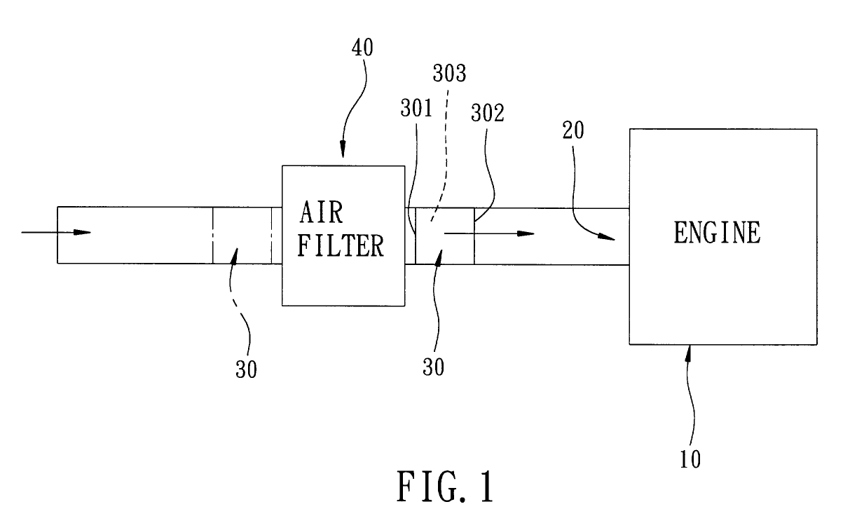

Referring to FIG. 1, the preferred embodiment of the vortex generator 30 according to the present invention is shown to be disposed anterior to the air intake port 20 of an internal combustion engine 10. The vortex generator 30 may be disposed between an air filter 40 and the air intake port 20 or anterior to an input side of the air filter 40. Moreover, the vortex generator of this invention may be built into the air intake port 20 or the air filter 40.

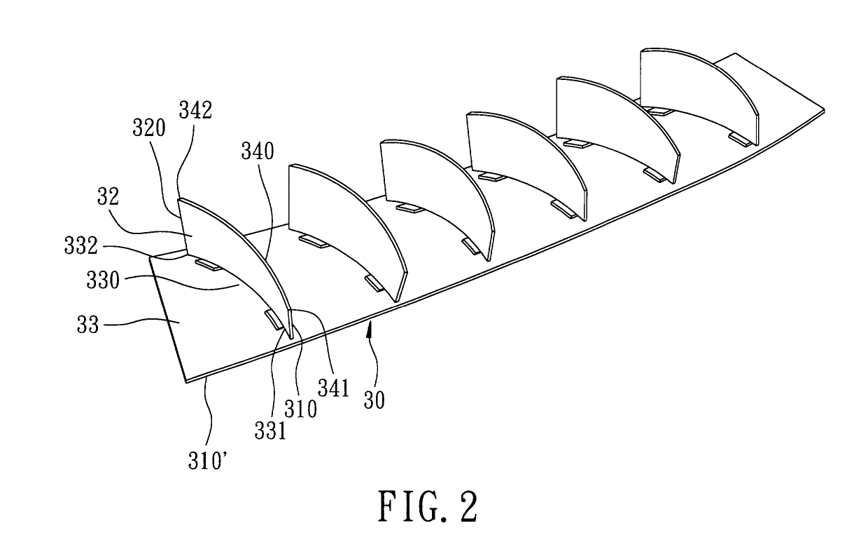

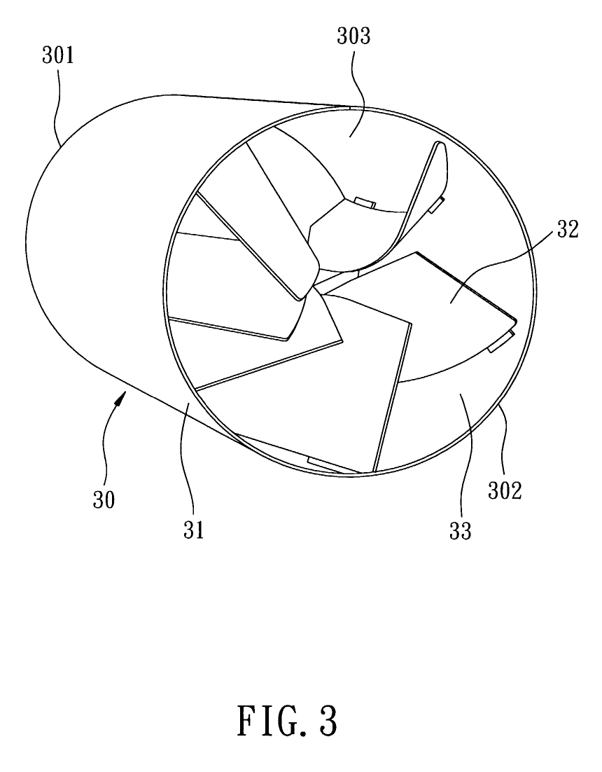

Referring further to FIGS. 2 and 3, the vortex generator 30 is shown to comprise a tubular body 31 and a plurality of curved blades 32.

The tubular body 31 is formed from a flexible plate 310′ that is rolled to surround a tube axis, and is formed with an air inlet 301, an air outlet 302, and an inner wall surface 33 that defines an air passage 303 extending from the air inlet 301 to the air outlet 302. The air inlet 301 and the air outlet 302 are adapted to be respectively disposed distal and proximate relative to the air intake port 20, as best shown in FIG. 1.

Each of the curved blades 32 is mounted in the air passage 303 on the inner wall surface 33 of the tubular body 31. The curved blades 32 cooperate to direct air that flows through the air passage 303 from the air inlet 301 to the air outlet 302 to form a vortex, which is supplied to the air intake port 20. As such, the vortex can mix with fuel in the engine 10 to result in an even air-fuel mixture that can enhance the combustion efficiency of the engine 10 so as to reduce both fuel consumption and air pollution.

Preferable, each of the curved blades 32 has a first curved edge 330, a first radial edge 310, a second curved edge 340 and a second radial edge 320. The first curved edge 330 is secured to the inner wall surface 33 of the tubular body 31 and is curved relative to the tube axis of the tubular body 31. The first curved edge 330 has a first end 331 adjacent to the air inlet 301 and a second end 332 adjacent to the air outlet 302. The first radial edge 310 extends radially from the first end 331 of the first curved edge 330 and has a first remote end 341 distal from the inner wall surface 33 of the tubular body 31. The second radial edge 320 extends radially from the second end 332 of the first curved edge 332 and has a second remote end 342 distal from the inner wall surface 33 of the tubular body 31. The second radial edge 320 is longer than the first radial edge 310. The second curved edge 340 interconnects the first and second remote ends 341, 342 of the first and second radial edges 310, 320.

At least one of the tubular body 31 and the curved blades 32 is coated with a ceramic coating that contains far infrared ray emitting particles to enrich oxygen content of the vortex which is supplied to the air intake port 20 to further improve the combustion efficiency.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A vortex generator adapted for use with an engine so as to enhance combustion efficiency of the engine, the engine having an air intake port, said vortex generator comprising:
a tubular body adapted to be disposed anterior to the air intake port and formed with an air inlet, an air outlet, and an inner wall surface that defines an air passage extending from said air inlet to said air outlet, said air inlet and said air outlet being adapted to be respectively disposed distal and proximate relative to the air intake port; and
a plurality of curved blades mounted in said air passage on said inner wall surface of said tubular body, said curved blades cooperating to direct air that flows through said air passage from said air inlet to said air outlet to form a vortex which is supplied to the air intake port;
whereby, the vortex mixes with fuel in the engine to enhance the combustion efficiency.

2. The vortex generator as claimed in claim 1, wherein each of said curved blades has:
a first curved edge secured to said inner wall surface of said tubular body and curved relative to a tube axis of said tubular body, said first curved edge having a first end adjacent to said air inlet and a second end adjacent to said air outlet;
a first radial edge extending radially from said first end of said first curved edge and having a first remote end distal from said inner wall surface of said tubular body;
a second radial edge extending radially from said second end of said first curved edge and having a second remote end distal from said inner wall surface of said tubular body, said second radial edge being longer than said first radial edge; and
a second curved edge interconnecting said first and second remote ends of said first and second radial edges.

3. The vortex generator as claimed in claim 2, wherein said tubular body is formed from a flexible plate that is rolled to surround the tube axis.

4. The vortex generator as claimed in claim 1, wherein said tubular body is formed from a flexible plate that is rolled to surround a tube axis.

5. The vortex generator as claimed in claim 1, wherein at least one of said tubular body and said curved blades is coated with a ceramic coating that contains far infrared ray emitting particles.
